(19) United States
(12) Patent Application Publication
(10) Pub. No.: US 2011/0219976 A1
(43) Pub. Date: Sep. 15, 2011

(54) METHOD OF PRINTING NEWSPAPERS

(76) Inventor: Russell Charles Crozier, JR., Los Angeles, CA (US)

(21) Appl. No.: 12/724,240

(22) Filed: Mar. 15, 2010

(51) Int. Cl. B41F 1/10

(52) U.S. Cl. 101/490

(57) ABSTRACT

A system and method is described for providing an insert in a finished newspaper which is printed by a different process than the process by which the newspaper itself is printed, yet where the insert is not inserted after the newspaper is printed, but while the newspaper is printed.

### BACKGROUND

The present invention relates to a system and method for printing and collating paper or substrate used in the production of newspapers. Specifically, the invention relates to a method of combining at least two technologies used in printing newspapers that have previously defied combination.

The printing of newspapers using lithography, or an “offset” printing process, is well known. A newspaper printing enterprise (or “printer”) typically uses this process to print newspapers. It is characterized by the following features: It uses thin metal plates with the image to be printed and non-image areas essentially on the same plane. One of these plates is wrapped on a cylinder. The process is based on the fact that oil and water do not mix, and it uses the offset principle in which ink is transferred or “offset” from the plate to a rubber blanket on an intermediate cylinder, and from the blanket to the paper which is wrapped on an impression cylinder. Both color ink and black ink are used in the offset process. While the term “paper” is used herein, that term should be understood to include any material or “substrate” upon which printing by a particular process is feasible.

The offset printing process used by newspapers is typically a cold offset (or, “coldset” or “non-heat”) process, in which the quality of the ink used, and the paper or substrate printed upon, is such that the ink, once applied to the paper, dries rapidly upon exposure to the atmosphere and ambient temperature. No heating, or forced drying, of the ink is required. The quality of paper or substrate used for newspapers is porous and of a coarse, inexpensive quality that is suitable for being read once and then disposed on the same day. It is commonly known as newsprint. This is in contrast with the paper used for printed matter such as glossy magazines and books, where relatively non-porous paper is used that has been treated to give it a glossy sheen. As a result of the elevated porosity in newsprint substrate used to print newspapers, the substrate absorbs more ink when ink is applied during the offset printing process. Moreover, the ink itself includes chemicals which are designed to cause the ink to dry rapidly in “cold” conditions and to leave a matt surface finish, thus allowing printing to take place without any forced drying by heating of the ink.

A further feature of the coldset offset process used by a newspaper printer includes the fact that individual colors may be printed onto a single page in serial fashion. Specifically, a roll of substrate is positioned on a spindle, and the leading edge of the roll, or “web,” is fed sequentially through four offset print units, each one configured to print one of the four colors of the subtractive color wheel, namely cyan, magenta, yellow, and key (black). The rapid drying allows multi color sequencing because the freshly printed ink dries rapidly to avoid smudging by the next print unit. As often happens, a single web fed through a series of four print units will include more than one page of a newspaper, and the web may be split into newspaper sized sheets before being folded and sold to the public. However, the printing of a newspaper may also typically require that at least one additional web be fed through a separate and different bank of four print units where color is to be applied to that web. This allows a newspaper of many color pages to be printed. Accordingly, printing a large newspaper may require more than one set of four offset print units. It will thus be appreciated that considerable expense is involved in acquiring the machinery needed for printing a large newspaper.

In another aspect of the printing industry, the printing of “glossy” magazines is also well known. Glossy magazines are so called because their pages appear to shimmer with gloss. This may be caused by a number of techniques. A higher quality of paper or substrate is produced when the substrate is mechanically buffed to render a less absorbent surface. A “supercalendered” substrate is produced when paper is passed through a number of rolls to give it a smooth and relatively impervious quality that allows a high quality print. A “gloss coated” substrate, a “dull coated” substrate, and a “matte coated” substrate are substrates that are all coated with a sealant compound that invites a high print quality suitable for “glossy” print productions. These coated substrates may also be buffed to enhance the gloss finish.

However, using a substrate suitable for “glossy” printing, a magazine printing enterprise typically uses a printing process that requires the freshly printed ink to be immediately heated after printing has taken place, and forced drying to take place. This is necessary because the gloss or coated finishes used for such printing reduce the porosity of the substrate which in turn tends to promote slow drying and smudging. The heating dries the ink more rapidly, and allows a finer print to be achieved. Heated printing may be achieved in a number of ways.

First, this effect may be achieved in the offset process by adding a heater element immediately after the print unit. The result is known as a heatset offset printing process. Heat may be applied in a heatset offset process, or other “non-coldset” processes, in a number of ways. Specifically, gas dryers, hot oil dryers, or electric dryers are used to generate heat in an oven through which the paper passes. Although there are several methods in use to generate the heat, it is only applied in an oven-type apparatus. This oven apparatus also captures volatile compounds from the ink that escape when heat is applied. Additional methods by which heat may be applied include ultraviolet radiation, or by electronic beam curing.

Another process for high quality printing is the “gravure” printing process (also known as the “intaglio” process) which is characterized by the following features: Gravure image areas consist of cells or wells etched or engraved into a copper cylinder. The un-etched surface of the cylinder represents the non-printing areas. The image cylinder rotates in a bath of ink. The excess ink is wiped off the surface of the cylinder by a flexible steel doctor blade. The ink remaining in the thousands of recessed cells forms the image by direct transfer to the paper or substrate as it passes between the plate cylinder and the impression cylinder. As with the heat offset process, heat is applied to the printed product immediately upon printing. Gravure printing produces excellent reproductions of pictures, especially color pictures, which is an effect highly desired when glossy magazines are used for advertising expensive merchandise.

Another type of printing process used to print high quality glossy pages is known as the flexographic printing process, also known as relief printing. A flexographic print is made by creating a positive mirrored master of the required image as a three dimensional relief in a rubber or polymer material. The image areas are raised above the non-image areas on the rubber or polymer plate. The ink is transferred from the ink roll which is partially immersed in the ink tank. Then it transfers to an anilox roll (or meter roll) whose texture holds a specific amount of ink because it is covered with thousands of small wells or cups that enable it to meter ink to the printing plate in a uniform thickness evenly and quickly (the number of cells per linear inch can vary according to the type of print job and the quality required). To avoid getting a final product with a smudgy or lumpy look, it must be ensured that the amount of ink on the printing plate is not excessive. This is achieved by using a scraper, called a doctor blade. The doctor blade removes excess ink from the anilox roller before inking the printing plate. The substrate is finally sandwiched between the plate and the impression cylinder to transfer the image. In this process, heat is also used to dry the ink immediately after printing, thus increasing the potential for high quality finished material.

It will be appreciated that the cold offset process on the one hand, and each of the other processes described herein are very different. If a newspaper enterprise uses the most cost effective method for printing its stock, it will use the coldset (or, non-heat) offset process that produces legible, inexpensive, yet poor quality printing on a low quality inexpensive paper. Practically all newspapers use this process.

Thus, using paper suitable for glossy printing in a printing unit configured to print by a cold offset process would almost invariably result in an unacceptable product. Because in a cold offset process there is no forced drying of the ink by heating, and because the paper for glossy printing lacks the high degree of porosity needed or for a cold printing process, the ink will tend to run before it dries, and will smudge the final product unacceptably. Thus, substrates adapted for glossy printing are not compatible with a cold offset printing process.

Yet, a newspaper printing enterprise will frequently wish to include, within the pages of a newspaper printed by cold offset process, a glossy high quality sheet of finely printed imagery and text advertising expensive merchandise. Hitherto, the only way that this result has been achievable has been to insert an already cut, pre-printed glossy sheet into a newspaper after the newspaper itself has been completely printed using the coldset offset process, and cut to length. To achieve this result, numerous inventions have been devised for inserting cut material from a remote source into printed and cut newspapers, some of which are referenced in U.S. Pat. No. 3,877,692, and U.S. Pat. No. 3,988,016.

Furthermore, attempts at combining one type of printing process with other types of printing processes have been made. For example, U.S. Pat. No. 5,429,698 describes a system in which an offset printing process is used in series with a gravure printing process, and indeed further in series with an inkjet printing process. In this approach, substrate webs are introduced into the printing process at the beginning of the process. These webs are then arranged to pass by or through each printing process in turn, so that a multiplicity of print types may be achieved, each to arrive at the end point in a common web stream where the document is cut to size. However, this kind of approach to achieving different types of printing in one final newspaper suffers from many shortcomings. First, the approach requires the user to purchase and maintain the equipment required for each kind of printing process that is desired in the system, and it also requires the user to develop or employ expertise in running each kind of printing system simultaneously. Thus, where a newspaper enterprise wishes to only occasionally insert, by the method disclosed in U.S. Pat. No. 5,429,698, a glossy sheet printed by a high quality process into a newspaper otherwise printed by the coldset offset process, the necessary acquisition of an entirely separate glossy printing process, along with an operating crew, would be necessary. Yet, this may represent a prohibitive cost.

In another aspect of the printing industry, standards of printing have been introduced to facilitate effective communication among those involved in the reproduction process. Thus, a purchaser of print will have some standard to enforce against the printer without having to spell out the required standard in a contract. Rather, the required standard may be incorporated by reference into a contract. Conversely, the printer will promulgate the same standard and may contractually require those who submit material for printing to conform their submissions to the same standard. The Specifications for Newsprint Advertising Production (SNAP) are designed to sustain reproduction quality in newsprint production and provide guidelines for the exchange of information. The specifications pertain to coldset (sometimes referred to as “non-heatset”) printing for all newsprint production on webs of paper, including offset lithography, direct lithography, letterpress, and flexography for a wide variety of products (e.g., newspapers, pre-printed advertising inserts, and other printed materials).

Yet, SNAP is not intended for high quality printing, nor is it intended for sheetfed, gravure, or heatset web offset processes. These latter processes are generally governed by other specifications that have been developed to provide guidance for them, such as the Specifications for Web Offset Publications (SWOP), which is an industry specification to define color data and its exchange for publication printing in the United States. Over the years SWOP has evolved from being an informal organization to having a board of directors beyond the original representatives from the Magazine Publishers of America, International Prepress Association, American Association of Advertising Agencies, and American Business Press and Web Offset Association of the Printing Industries of America. SWOP is generally regarded for specifying web-offset printing, but the specification also specifies gravure publication printing. Over the last thirty years SWOP has become a major factor in the success of the Publication Printing Industry in the United States. The resulting recommended specifications have become ubiquitous for all those involved in the production of publications.

As used herein, the important distinguishing standard between the SNAP and SWOP standards is that SNAP requires the use of an ink having total ink density up to, but not exceeding 240% (out of a maximum of 400%) and SWOP anticipates the use of ink having a total ink density above, but not less than 240%. A coldset offset process will, in practically all cases, be incapable of using ink having a total ink density greater than 240%. On the other hand, other processes such as the gravure process, or the flexographic process, or the heat offset process, may use ink having a total ink density higher than 240%. The higher density ink produces a much finer quality print, whereas the lower density ink, below 240%, is suitable for and required for successful newsprint

Thus, a further problem encountered in the printing industry is that a purchaser of printed matter may require a newspaper or magazine to be provided that includes an insert printed under the higher ink density standard for higher print quality, together with sheets printed under the lower ink density standard for lower and less expensive quality. This has hitherto been achieved only by the expensive and complex method of placing a high quality print insert into the newspaper after it has been printed and cut, thus requiring extra labor and machinery.

Thus, there is a need in the art of printing newspapers to introduce a system and method for solving the problems outlined above. The present invention addresses these and other needs.

### SUMMARY OF THE INVENTION

The present invention is a method of producing a newspaper that includes pages printed by more than one printing process. In a first preferred embodiment of the invention, the method comprises providing a length of first substrate. Then, a series of imprints are imprinted onto the first substrate using a first printing process. The first substrate that has been printed is rolled into a first roll of printed substrate. A printed first web of the first roll is configured to follow a web path, in which the first web is not further printable by any printing unit. A first printing unit is provided that is adapted to use a second printing process which is incapable of providing the first printing process. A second roll, of second substrate that is unprinted, is provided. A second web, of the second roll, is extended through the first printing unit, and the second web is printed on with the first printing unit using the second printing process, thereby producing a printed second web. Finally, the printed first web and the printed second web are merged into a single web stream, and the web stream is cut into equal lengths to form a printed newspaper. As a result of this method, a finished newspaper emerges after the cutting step, fully assembled and folded, but including printed pages that derive from totally different printing processes. No additional labor is required to insert one printed page with the rest of the newspaper, resulting in considerable cost savings where such insert is desired.

In a preferred aspect of this embodiment, printing a series of imprints onto the first substrate using a first printing process includes using a first printing process selected from one of a heat offset printing process, a gravure printing process, and a flexographic printing process. Furthermore, providing a first printing unit adapted to use a second printing process which is incapable of providing the first printing process includes using a cold offset process as the second printing process. The first printing process requires the ink to be heated after printing and this cannot be achieved using a print unit capable of achieving the second printing process which is a cold process. Nevertheless, a single newspaper can be accomplished with little effort that includes both pages printed by both the first and the second process.

In a second embodiment, the invention comprises providing a length of first substrate. A series of imprints is then imprinted onto the first substrate using a first printing process. The first substrate that has been printed is rolled into a first roll of printed substrate. A printed first web of the first roll is configured to follow a web path wherein the first web is not further printable by any printing unit. A first printing unit is provided, the unit being adapted to use a second printing process which is incompatible for printing on the first substrate. A second roll of second substrate that is unprinted is provided, and a second web of the second roll is extended through the first printing unit. The second web is printed upon with the first printing unit using the second printing process, thereby producing a printed second web. The printed first web and the printed second web are merged into a single web stream. Finally, the web stream is cut into equal lengths to form a printed newspaper.

In a preferred aspect of this embodiment, providing a length of first substrate includes providing a length of substrate selected from at least one of: buff substrate, supercalendered substrate, gloss coated substrate, dull coated substrate, and matte coated substrate. Furthermore, providing a first printing unit adapted to use a second printing process which is incompatible for printing on the first substrate includes providing a first unit adapted to use a coldset offset printing process for printing on newsprint. Notably, coldset offset print units are incompatible for printing on the length of first substrate as listed, because each of the first substrate types requires heating after printing to adequately dry the ink. Without heating, printing on the first substrate types results in unacceptable smudging.

In a third preferred embodiment, the invention comprises providing a length of first substrate. A series of imprints is printed onto the first substrate using a first printing process applying a first printing standard. The first substrate that has been printed is rolled into a first roll of printed substrate. A printed first web of the first roll is configured to follow a web path wherein the first web is not further printable by any printing unit. A first printing unit is provided, the unit being adapted to use a second printing process that does not satisfy the first printing standard. A second roll of second substrate that is unprinted is provided. A second web of the second roll is extended through the first printing unit. The second web is printed on with the first printing unit using the second printing process, thereby producing a printed second web. The printed first web and the printed second web are merged into a single web stream. The web stream is finally cut into equal lengths to form a printed newspaper.

In a preferred aspect of the third embodiment, printing a series of imprints onto the first substrate using a first printing process applying a first printing standard includes printing onto the first substrate using an ink having a total ink density greater than 240%. Furthermore, providing a first printing unit adapted to use a second printing process that does not satisfy the first printing standard includes providing a first printing unit adapted to apply an ink having total ink density less than 240%.

In a preferred aspect of each of the three embodiments, configuring a printed first web of the first roll to follow a web path wherein the first web is not further printable by any printing unit includes not extending the first web through any printing unit. Alternatively, the same includes extending the first web through a second printing unit, and configuring the second printing unit to allow the first web to pass through the second printing unit without any printing taking place. Moreover, merging the printed first web and the printed second web into a single web stream includes registering printed pages on the first web with printed pages on the second web.

These and other advantages of the invention will become more clearly apparent with reference to the figures and the detailed description of the preferred embodiments.

### BRIEF DESCRIPTION OF THE DRAWINGS

FIG. 1 is a schematic view, in side elevation, of an offset printing process that is known in the prior art.

FIG. 2a is a schematic view, in side elevation, of a printing system having features of the present invention in a first embodiment.

FIG. 2b is a schematic view, in side elevation, of a variation to an aspect of FIG. 2a.

FIG. 3 is a schematic view, in side elevation, of a printing system having features of the present invention in a second embodiment.

### DETAILED DESCRIPTION OF THE PREFERRED EMBODIMENTS

With reference to the drawings, which are provided by way of exemplification and not limitation, a system and method of printing and collating newspaper is described having features of the present invention.

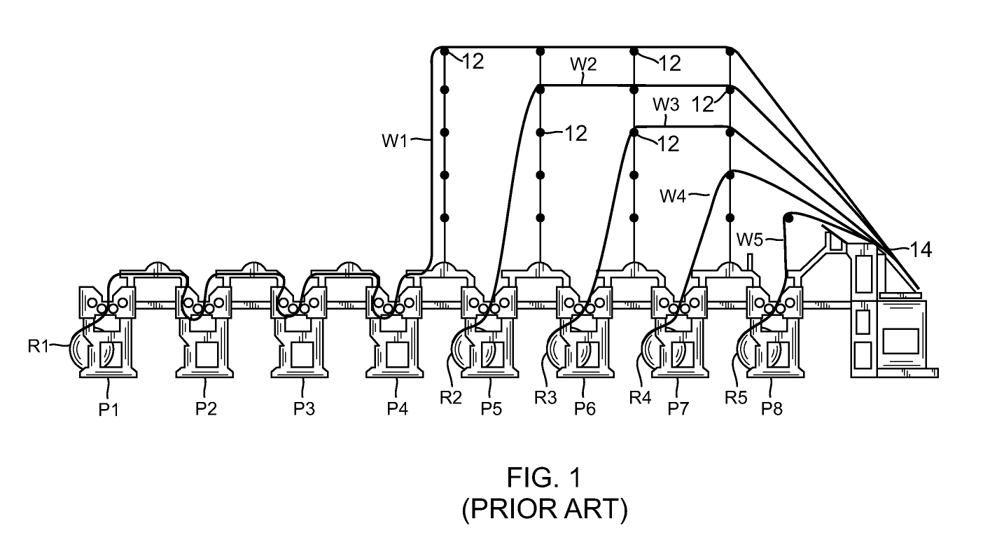

In a preferred embodiment, the system and method of the invention relies initially on a standard printing system using a coldset offset printing process for printing newspapers. Under the principles of the present invention, a standard prior art printing system is modified to enable the novel features of the invention to be performed. A standard prior art coldset offset printing system known in the art is exemplified in FIG. 1, which schematically shows printing units and their interrelationship with each other and the paper rolls (and their associated “webs”) that are fed through the units in the printing process. As described above, the units are capable only of using the cold offset method of printing, under the lower SNAP standard, or using ink having a total ink density of less than 240%. Specifically, FIG. 1 shows a series of offset print units, each identified by the letter P, so that the system may employ P_{1-N} print units. Typically, the print units will be provided in sets of four, so that each of the four colors (cyan, magenta, yellow, and key) used for printing on white paper may be applied. Associated with the first set of four print units P₁₋₄ is situated a roll R₁ and its extending web W₁ of newspaper print paper, so that the system may employ W₁₋ₘ webs of newspaper print paper or substrate. (In some smaller configurations of a printing system, the web may be situated alongside the print unit rather than beneath it as shown in FIG. 1.)

According to the terminology used herein, a roll of paper may be partially unrolled to provide an attached “web” of paper that can be extended through a printing process. The roll unwinds to feed the web, and the web flows through the printing process, eventually joining other webs in a web stream that is eventually cut into equal lengths to provide a printed newspaper having a plurality of pages.

Thus, FIG. 1 exemplifies how a first web W₁ feeds off its roll R₁ from below a first printing unit P₁ and then passes into the printing unit P₁ where the coldset offset printing process takes place. During this process, the printing unit imparts a first color print (for example cyan) to the web W₁, with the result that a single imprint is made multiple times in sequence on the web as the web passes through the unit. The distance between one imprint and the next imprint is the length of the eventual newspaper. These pages will eventually be separated from each other, by guillotine cutting, towards the end of the printing process. The web W₁ is then configured to pass into and through the second printing unit P₂, where the coldset offset process takes place again, and a second color (for example magenta) is imprinted on the web to supplement the first color and build up the image that is intended for eventual publication. It will be appreciated that it is extremely important that the imprint of second color be in precise registration with the imprint of first color. To this end, methods of registration between one printing unit and the next are known and employed. The web W₁ is then configured to pass into and through the third printing unit P₃, where the offset process takes place again, and a third color (for example yellow) is imprinted on the web. The same registration requirements apply. The web W₁ is then configured to pass into and through the fourth printing unit P₄, where the offset process takes place again, and a fourth color (for example key, or black) is imprinted on the web. The resulting product is a web that may include sequential images of four sheets of a newspaper, printed side by side and on both sides. At a later stage, the web may be split into two leaves of a newspaper, that will be folded at a center hinge to produce a copy of a newspaper. Referring still to FIG. 1, the web W₁ passes from the fourth printing unit P₄ and upwardly to bend around a strategically positioned “angle bar” 12 that is configured to change the direction of movement of a web, or to maintain support for a direction of movement that is established. To this end, FIG. 1 shows a plurality of angle bars 12 positioned at strategic positions above the set of print units. The web W₁ then moves horizontally over further angle bars, and finally downwardly to join a web stream 14 of additional webs W_{2-N}.

Still with reference to FIG. 1, second, third, fourth and fifth rolls of substrate R₂, R₃, R₄, and R₅, each with an associated web W₂, W₃, W₄, and W₅ are each positioned below print units P₅, P₆, P₇, and P₈, which are configured in this example to apply only one color, black, to each of the respective webs. In a similar fashion, W₂, W₃, W₄, and W₅, are passed through their associated print units P₅, P₆, P₇, and P₈ to have a repeating printed image applied. Each of these webs then passes upwardly from its associated printing unit, and is angled sideways by an angle bar 12 to join a web stream 14 of webs that have each been printed on, and are ready for further processing.

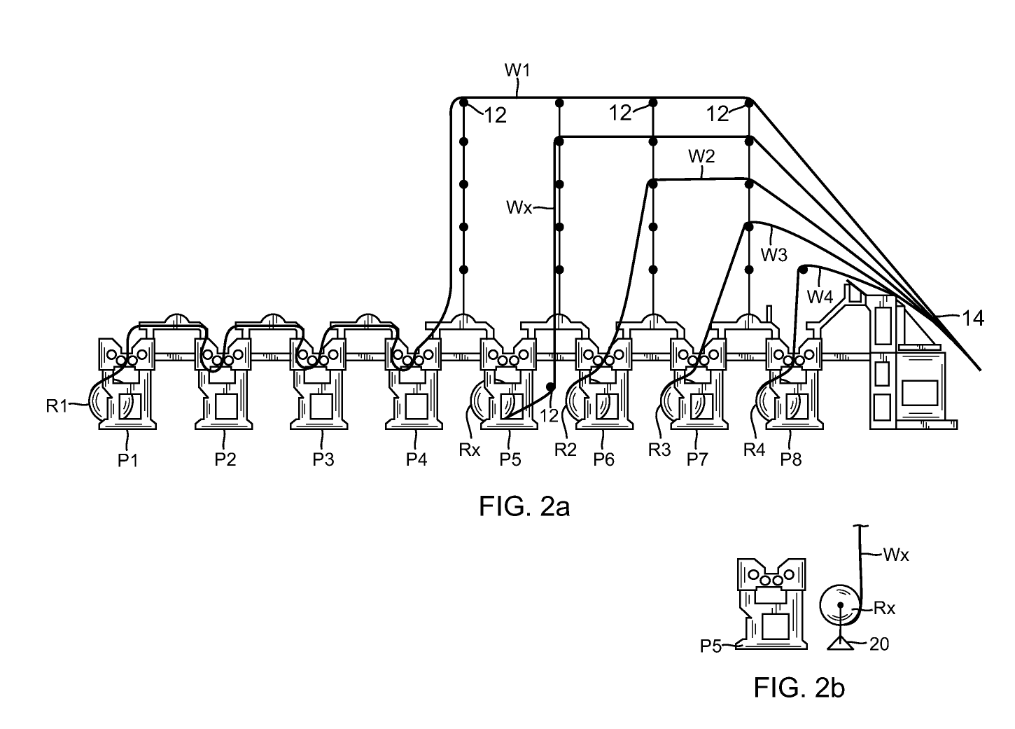

Against this background of known art as described with reference to FIG. 1, the present invention is described with reference to FIG. 2, where the configuration of the printing system shown in FIG. 1 is modified in accordance with the principles of the present invention to accommodate a desire, by a printing enterprise that owns the printing units P_{1-N}, to insert into the printed newspaper for example at the second page or web (as exemplified in FIG. 2) a glossy sheet printed by a different process than the coldset offset process being used by print units P_{1-N}—for example, a heatset offset printing process, a gravure printing process, or a flexographic printing process, each of which is capable of providing a print quality of a much higher standard or quality than the coldset offset process of which print units P_{1-N} are capable, as has been noted above.

Under the principles of the present invention and with reference to FIG. 2, the first web W₁ of FIG. 2 follows the same path as it did in FIG. 1. This will ensure that a front page is printed on newsprint by the four color cold offset process as a first page of the newspaper. However, in contrast with FIG. 1, rolls R₂, R₃ and R₄ with their extending webs of empty newsprint W₂, W₃, and W₄ are each shifted to the right by one unit, perhaps bumping off a roll R₅ at the end, leaving an opening under print unit P₅ where roll R₂ and web W₂ was situated in FIG. 1. Into the opening created beneath print unit P₅ there may be inserted a roll Rx of pre-printed material, that was printed for example at a location offsite from where print units P_{1-N} are located, and rolled into roll Rx. This offsite printing would have been done on a substrate of a quality unsuitable for, and indeed incapable of being printed by, the cold offset printing utilized by units P_{1-N}, and thus would have used a printing process that is not the offset process used by print units P_{1-N}. For example the pre-printed roll Rx may be a roll of substrate printed using the gravure process on buffed substrate. Thus the roll may contain a series of pre-printed pages, joined end to end, each page having exactly the same length as the length of the newspaper to be printed by the units P₁₋₄, and P₆₋₈ of the present example. As seen in the embodiment of FIG. 2, the web Wx of roll Rx is configured to not pass through print unit P₅ but to pass around the side of it, and then to extend upwardly to an angle bar 12 around which it is turned sideways, and to be positioned as the second web in the stream 14 flowing towards the collation and cutting process.

In an alternative embodiment of this aspect of the invention, the roll Rx may be positioned on a roll stand 20 located beside the print unit P₅ as seen in FIG. 2b, so that the web Wx extends upwardly to bypass print unit P₅. It will be appreciated that, by passing around the side of print unit P₅, the pre-printed glossy insert web of roll Rx is not printed upon during the process that follows. Indeed, the quality of substrate in roll Rx would render it unsuitable for offset printing. However, the net result is that a sheet of high quality glossy printed matter is automatically inserted into a newspaper printed otherwise by lower quality coldset offset process. No additional labor is required to insert the sheet into the newspaper after the newspaper is printed. No additional mechanical process is required to insert the sheet into the newspaper after it is printed. Rather, the newspaper rolling off the press is folded and ready for delivery, and includes a glossy printed sheet within in its pages at a desired location (in this example, page 2).

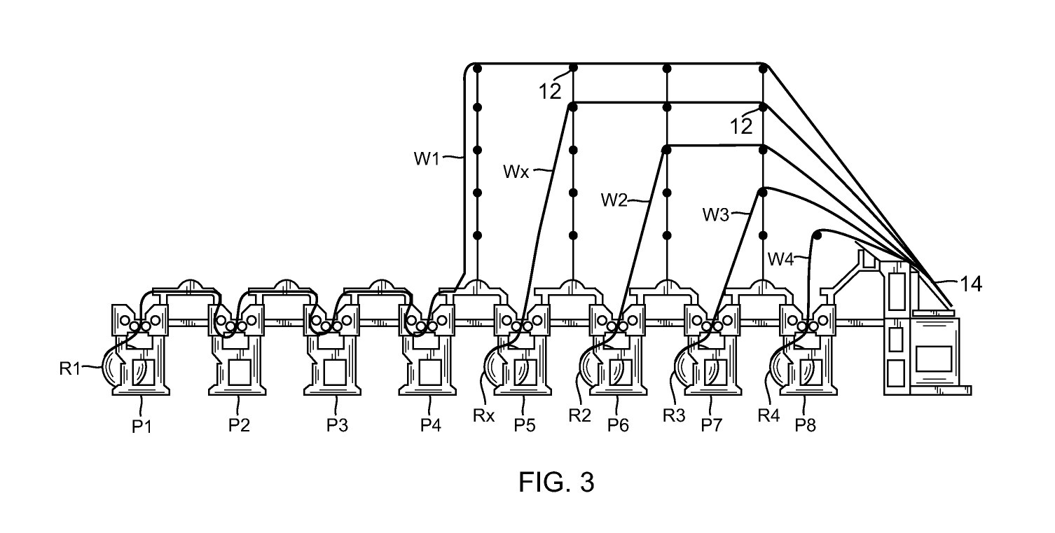

In a second preferred embodiment, as exemplified in FIG. 3, the pre-printed roll Rx may be positioned beneath print unit P₅, as in the embodiment of FIG. 2a, but the web Wx feeding off the roll Rx passes through the print unit P₅, rather than passing around it. In this case, print unit P₅ is set so that no printing takes place as the web Wx flows through the print unit. Thus, the web Wx flows into the common web stream 14 just as in the previous embodiment, with the same advantageous result.

The same methodology as above may be followed where it is specifically desired to mix two standards of printing in a single newspaper. (In fact, using two different standards may well require, and typically does require, that two different printing processes be used for the roll Rx and the other rolls R_{1-N}.) So, for example, a newspaper may be called for that is generally printed using the SNAP standard of printing as described above, or that may use an ink having total ink density less than 240%, but that must have an insert printed on a higher standard, such as the SWOP standard, that may require an ink having a total ink density higher than 240%. In other words, a printing enterprise may own print units P_{1-N} that are configured only to print under the lower, or SNAP, standard but the purchaser of the final product requires an insert of higher quality. Instead of specifying the printing process for the insert, the purchaser specifies a higher print standard for the insert, namely SWOP, or using an ink having total ink density higher than 240%. Here, under the principles of the invention, a length of substrate is pre-printed using the SWOP standard (or ink having total ink density higher than 240%) on a separate printing press. When printed, the substrate is rolled into a roll Rx that may be inserted according to the method of the invention beneath or adjacent a unit P₅ that is configured to print using only the lower SNAP standard, but the web Wx is diverted around the unit P₅. (Alternatively, if, as in the embodiment shown in FIG. 3, web Wx is directed through the unit P₅ then that unit is set so that no printing can take place on web Wx.) The other units P₁₋₄, and P₆₋₈ are loaded with rolls R₁₋₄. The print units P₁₋₄, and P₆₋₈ then each print their portions of the newspaper, and web Wx is taken up along with webs W₁₋₄ in a common web stream 14, as before, to produce a newspaper that includes an insert having a much higher quality printing standard than the rest of the newspaper.

Again, the same methodology as above may be followed where it is specifically desired to mix two different kinds of substrate in a single newspaper. So, for example, a newspaper may be called for that is generally printed using common newsprint, but that must have an insert printed on substrate suitable for glossy printing such as “supercalendered,” substrate “gloss coated” substrate, “dull coated,” and “matte coated” substrate.

In other words, a printing enterprise may own print units P_{1-N} that are configured only to print on newsprint. Instead of specifying the printing process for the insert, the purchaser specifies an insert printed on a type of paper suitable for glossy printing, but incompatible with newspaper printing process. Here, under the principles of the invention, a length of substrate is pre-printed using the type of paper (specified by the purchaser) suitable for glossy printing on a separate printing press. When printed, the glossy substrate is rolled into a roll Rx that may be inserted according to the method of the invention beneath or adjacent a unit P₅ that is configured to print using only the lower quality newsprint, but the web Wx is diverted around the unit P₅. (Alternatively, if, as in the embodiment shown in FIG. 3, web Wx is directed through the unit P5 then that unit is set so that no printing can take place on web Wx.) The other units P₁₋₄, and P₆₋₈ are loaded with rolls R₁₋₄. The print units P₁₋₄, and P₆₋₈ then each print their portions of the newspaper, and web Wx is taken up along with webs W₁₋₄ in a common web stream 14, as before, to produce a newspaper that includes an insert having a much higher paper quality than the rest of the newspaper that is printed on newsprint.

Thus there has been described a novel method for introducing substrate and printing of a second process and/or standard into a newspaper on a substrate of a first kind—before the newspaper has been cut. This inventive method has the advantage of not requiring any additional labor, or insertion process. It merely requires installing a roll Rx of substrate that has been previously printed using a desired printing process, or a desired standard, or a desired substrate (all of which are incapable of being printed by units P_{1-N}) and feeding a web Wx from that roll into the printing system. In one embodiment, feeding the web Wx into the printing system will involve bypassing the printing units, and joining the web Wx with the printing system at the stage that other webs are fed into an array of angle bars, that will divert all the webs toward the final web stream 14, prior to being cut. (In another embodiment, feeding the web Wx into the printing system may involve passing the web through a printing unit, but setting that unit not to apply any printing process to the web Wx as it passes through.) In the final result, the resulting newspaper automatically includes an additional sheet of paper that was printed by none of the print units which printed the balance of the newspaper, but that may be of a substantially higher or different quality, a quality that units P_{1-N} are not capable of achieving.

Thus, the present invention addresses with novel and useful features certain needs that are found in the art. The present invention may, of course, be carried out in other specific ways than those herein set forth without departing from the essential characteristics of the invention. The present embodiments are, therefore, to be considered in all respects as illustrative and not restrictive, while the scope of the invention is set forth in the claims that follow.

I claim:

1. A method of producing a newspaper that includes pages printed by more than one printing process, comprising:
providing a length of first substrate;
printing a series of imprints onto the first substrate using a first printing process;
rolling the first substrate that has been printed into a first roll of printed substrate;
configuring a printed first web of the first roll to follow a web path wherein the first web is not further printable by any printing unit;
providing a first printing unit adapted to use a second printing process which is incapable of providing the first printing process;
providing a second roll of second substrate that is unprinted, and extending a second web of the second roll through the first printing unit;
printing on the second web with the first printing unit using the second printing process, thereby producing a printed second web;
merging the printed first web and the printed second web into a single web stream; and then
cutting the web stream into equal lengths to form a printed newspaper.

2. The method of claim 1, wherein,
printing a series of imprints onto the first substrate using a first printing process includes using a first printing process selected from one of a heat offset printing process, a gravure printing process, and a flexographic printing process; and
providing a first printing unit adapted to use a second printing process which is incapable of providing the first printing process includes using a cold offset process as the second printing process.

3. The method of claim 1, wherein configuring a printed first web of the first roll to follow a web path wherein the first web is not further printable by any printing unit includes not extending the first web through any printing unit.

4. The method of claim 1, wherein configuring a printed first web of the first roll to follow a web path wherein the first web is not further printable by any printing unit includes extending the first web through a second printing unit, and configuring the second printing unit to allow the first web to pass through the second printing unit without any printing taking place.

5. The method of claim 1, wherein merging the printed first web and the printed second web into a single web stream includes registering printed pages on the first web with printed pages on the second web.

6. A method of producing a newspaper that includes pages printed by more than one printing process, comprising:
providing a length of first substrate;
printing a series of imprints onto the first substrate using a first printing process;
rolling the first substrate that has been printed into a first roll of printed substrate;
configuring a printed first web of the first roll to follow a web path wherein the first web is not further printable by any printing unit;
providing a first printing unit adapted to use a second printing process which is incompatible for printing on the first substrate;
providing a second roll of second substrate that is unprinted, and extending a second web of the second roll through the first printing unit;
printing on the second web with the first printing unit using the second printing process, thereby producing a printed second web;
merging the printed first web and the printed second web into a single web stream; and then cutting the web stream into equal lengths to form a printed newspaper.

7. The method of claim 10, wherein:
providing a length of first substrate includes providing a length of substrate selected from at least one of buff substrate, supercalendered substrate, gloss coated substrate, dull coated substrate, and matte coated substrate, and
providing a first printing unit adapted to use a second printing process which is incompatible for printing on the first substrate, includes providing a first unit adapted to use a coldset offset printing process for printing on newsprint.

8. The method of claim 6, wherein configuring a printed first web of the first roll to follow a web path wherein the first web is not further printable by any printing unit includes not extending the first web through any printing unit.

9. The method of claim 6, wherein configuring a printed first web of the first roll to follow a web path wherein the first web is not further printable by any printing unit includes extending the first web through a second printing unit, and configuring the second printing unit to allow the first web to pass through the second printing unit without any printing taking place.

10. The method of claim 6, wherein merging the printed first web and the printed second web into a single web stream includes registering printed pages on the first web with printed pages on the second web.

11. A method of producing a newspaper that includes pages printed by more than one printing process, comprising:
providing a length of first substrate;
printing a series of imprints onto the first substrate using a first printing process applying a first printing standard;
rolling the first substrate that has been printed into a first roll of printed substrate;
configuring a printed first web of the first roll to follow a web path wherein the first web is not further printable by any printing unit;
providing a first printing unit adapted to use a second printing process that does not satisfy the first printing standard;
providing a second roll of second substrate that is unprinted, and extending a second web of the second roll through the first printing unit;
printing on the second web with the first printing unit using the second printing process, thereby producing a printed second web;
merging the printed first web and the printed second web into a single web stream; and then
cutting the web stream into equal lengths to form a printed newspaper.

12. The method of claim 11, wherein:
printing a series of imprints onto the first substrate using a first printing process applying a first printing standard includes printing onto the first substrate using an ink having a total ink density greater than 240%; and
providing a first printing unit adapted to use a second printing process that does not satisfy the first printing standard includes providing a first printing unit adapted to apply an ink having total ink density less than 240%.

13. The method of claim 11, wherein configuring a printed first web of the first roll to follow a web path wherein the first web is not further printable by any printing unit includes not extending the first web through any printing unit.

14. The method of claim 11, wherein configuring a printed first web of the first roll to follow a web path wherein the first web is not further printable by any printing unit includes extending the first web through a second printing unit, and configuring the second printing unit to allow the first web to pass through the second printing unit without any printing taking place.

15. The method of claim 11, wherein merging the printed first web and the printed second web into a single web stream includes registering printed pages on the first web with printed pages on the second web.
